(19) United States
(12) Patent Application Publication
(10) Pub. No.: US 2009/0132506 A1
(43) Pub. Date: May 21, 2009

(54) METHODS AND APPARATUS FOR INTEGRATION OF VISUAL AND NATURAL LANGUAGE QUERY INTERFACES FOR CONTEXT-SENSITIVE DATA EXPLORATION

(75) Inventors: Keith C. Houck, Rye, NY (US); Peter Kissa, Ossining, NY (US); Shimei Pan, Armonk, NY (US); Michelle X. Zhou, Briarcliff Manor, NY (US)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 11/943,405

(22) Filed: Nov. 20, 2007

(51) Int. Cl. G06F 17/30

(52) U.S. Cl. 707/4; 707/E17.015

(57) ABSTRACT

Methods and apparatus are provided for integrating a visual query interface and a natural language interface. The disclosed interface embeds a first of the visual query interface and the natural language interface into a second of the visual query interface and the natural language interface. The disclosed interface can also receives one or more natural language expressions in the natural language interface and one or more visual query expressions in the visual query interface in a same search turn. The disclosed interface can also receive a first query comprised of a first of a natural language query and a visual query; process the first query; and creates a substantially equivalent query to the first query in a second of the natural language query and the visual query The disclosed interface can process a natural language query to determine if a portion of the natural language query is not understood; and convert at least a portion of the natural language query to a visual query.

### FIELD OF THE INVENTION

The present invention relates generally to interfaces for visual and natural language queries and, more particularly, to a method and apparatus for integrating visual and natural language queries for context-sensitive data access and exploration.

### BACKGROUND OF THE INVENTION

A number of user interface technologies have been developed to aid users in accessing and exploring large and complex data sets. Broadly, these technologies fall into two categories: visual query and natural language interfaces. Natural language interfaces include both text and speech-based interfaces.

Visual query interfaces allow users to express their data needs in a graphical user interface (GUI) Since a visual query language often represents the underlying data model directly, it is straightforward and robust to translate a visual query into an executable data query (e.g., SQL query). Like any WIMP (Windows, Icons, Menus, and Pointing) interface, visual query interfaces are typically easy to learn and help users to express their information needs with the visibility of GUI prompts. However, visual query interfaces also share the limitations of WIMP interfaces. In particular, authoring a visual query can be time consuming. Since a visual query interface is usually rigid, it requires familiarity with the underlying data model and requires users to precisely map their data needs to the underlying data model. As the data sets get larger and more complex, it becomes more challenging to use a visual query interface. Such interfaces become inundated with information and more difficult to navigate.

Natural language (NL) interfaces, on the other hand, allow users to directly express their information needs without worrying about the details of the underlying data model. However, natural language expressions are often diverse and imprecise, requiring linguistic knowledge and sophisticated reasoning to accurately interpret these inputs. Due to the poor interpretation performance, natural language interfaces have not gained wide acceptance in practice.

To take advantage of the strength of both interfaces and to overcome their deficiencies, there exists a need to integrate visual and natural language query interfaces so that the combined query interface is effective, easy to use, and robust A simple integration of the two interfaces, such as putting them side-by-side or using them turn-by-turn, however, may not adequately support effective context-sensitive data exploration

### SUMMARY OF THE INVENTION

Generally, methods and apparatus are provided for integrating a visual query interface and a natural language interface. According to a first aspect of the invention, the integrated interface provides an interface that embeds a first of the visual query interface and the natural language interface into a second of the visual query interface and the natural language interface. The interface can receive one or more natural language expressions in a visual query. The disclosed interface processes each visual query element in the visual query and applies NL interpretation to each NL expression in the visual query. Likewise, the interface can receive one or more visual query expressions in a natural language query To process the visual query expressions, the interpretation dictionary used by an NL query interpreter is augmented with one or more graphical symbols.

According to a second aspect of the invention, the integrated interface provides the visual query interface and the natural language interface; receives one or more natural language expressions in the natural language interface; receives one or more visual query expressions in the visual query interface in a same search turn as the one or more natural language expressions are received; and processes the one or more natural language expressions and the one or more visual query expressions in the same search turn. The one or more natural language expressions can be applied to an NL interpreter and the one or more visual query expressions can be applied to a visual query interpreter. The results from the visual query mode and the natural language mode can be integrated.

According to a third aspect of the invention, the integrated interface provides the visual query interface and the natural language interface; receives a first query comprised of a first of a natural language query and a visual query; processes the first query; and creates a substantially equivalent query to the first query in a second of the natural language query and the visual query. The substantially equivalent query can be provided for editing as a basis for a subsequent query.

According to a fourth aspect of the invention, the integrated interface provides the visual query interlace and the natural language interface; receives a natural language query; processes the natural language query to determine if a portion of the natural language query is not understood; and converts at least a portion of the natural language query to a visual query; and receives one or more visual constraints to specify the portion of the natural language query is not understood. The natural language query can be applied to a natural language interpreter. An interpretation result can be formulated based on a portion part of the natural language query that is understood (for example, —by ignoring one or more unknown words). The partial interpretation result can be converted to a visual query. One or more revisions to the visual query can be received that describe one or more unknown words or to otherwise correct an interpretation error in the visual query.

A more complete under standing of the present invention, as well as further features and advantages of the present invention, will be obtained by reference to the following detailed description and drawings.

### BRIEF DESCRIPTION OF THE DRAWINGS

FIG. 1 is a schematic block diagram illustrating an integrated query interface system in accordance with the present invention;

FIG. 2 is a flow diagram illustrating intra-modality integration in accordance with an embodiment of the present invention;

FIG. 3 is a flow diagram illustrating inter-modality intra-turn side-by-side integration in accordance with an embodiment of the present invention;

FIG. 4 is a flow diagram illustrating inter-modality intra-turn context-preserving integration in accordance with an embodiment of the present invention;

FIG. 5 is a flow diagram illustrating cross-modality natural language error recovery using visual queries in accordance with an embodiment of the present invention.

### DETAILED DESCRIPTION OF PREFERRED EMBODIMENTS

The present invention provides a combined visual and natural language query interface. The disclosed integration techniques blend the use of visual query and natural language interfaces for complex data access and exploration tasks.

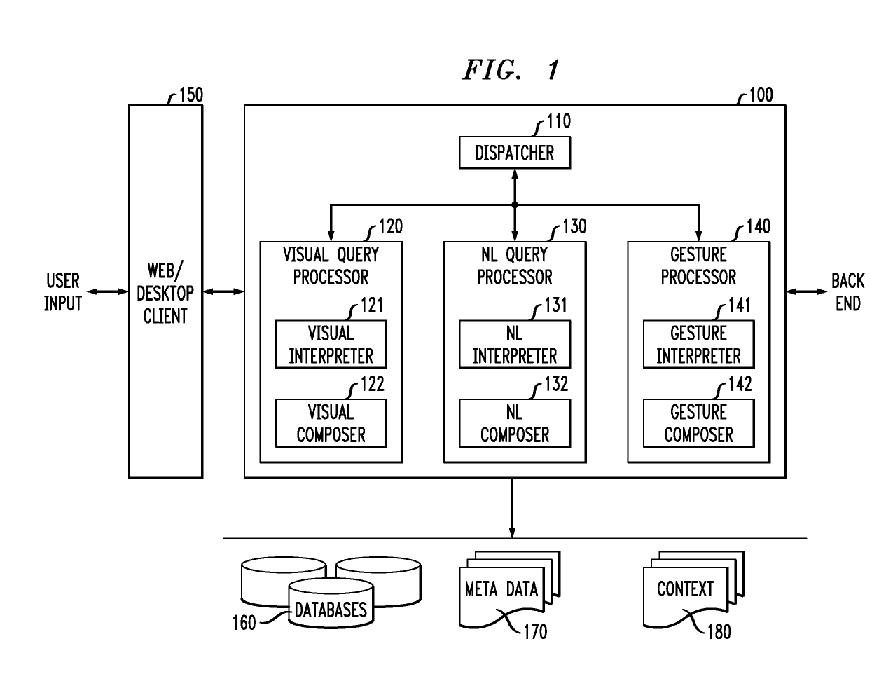

FIG. 1 is a schematic block diagram illustrating an integrated query interface system 100 in accordance with the present invention. As shown in FIG. 1, the exemplary system 100 comprises a visual query processor 120 and an NL query processor 130. In addition, the system optionally includes a dispatcher 110 and a gesture processor 140.

The exemplary visual query processor 120 contains a visual query interpreter 121 and a visual query composer 122. Given the semantic representation of a query, the visual query composer 122 automatically generates a graphical representation of the visual query. The visual query interpreter 121 translates a user-authored visual query into the semantic representation of a data query.

The natural language processor 130 includes an NL interpreter 131 and an NL composer 132 for interpreting and synthesizing NL queries, respectively.

With both the visual query processor 120 and the NL query processor 130, the system 100 is able to automatically construct a visual query interface based on an NL query (using the NL query interpreter 131 and the visual query composer 122). Similarly, the system can also automatically construct an NL query based on a user-authored visual query (using the visual query interpreter 121 and the NL query composer 132) Furthermore, the system 100 can also automatically construct an equivalent visual and an equivalent NL query interface for an input query that is partially visual and partially NL.

The optional dispatcher 110 serves as a command center that coordinates the visual query processor 120 and the NL query processor 130 or other optional modality-specific input processor to support different intelligent integration strategies. The dispatcher 110 also communicates with components outside the query interface, such as a back end for data access and data presentation. This component is optional if the modality-specific input processors can communicate to each other and to the outside components directly.

The optional gesture processor 140 contains a gesture interpreter 141 that interprets a user's deictic gestures, such as pointing and selection. The gesture processor 140 also contains a gesture composer 142 to confirm a gesture event visually, such as highlighting an object that is referred by the current gesture.

A client 150 renders the visual and natural language query interface inside a web browser or on a desktop display, in a known manner. As shown in FIG. 1, the disclosed integrated query interface typically relies on a number data sources. For example, the system 100 can be connected to a database server 160 to access domain data. The system can also communicate with a number of knowledge sources 170, 180 that maintain the application's meta data (e.g., domain ontology, presentation meta data, and dictionary) and conversation context (e.g., conversation history and user preferences).

Generally, in the following discussion, the modalities in the exemplary embodiment correspond to visual query or NL query modes. The term “intra-turn” means within the same query. The term “inter-turn” means across a number of queries.

### Intra-Modality Integration

According to one aspect of the present invention, an intra-modality integration strategy is employed to integrate visual and natural language techniques. The disclosed intra-modality integration allows one query modality (e.g., natural language) to be embedded in the other (e.g., GU). For example, in the current invention, natural language expressions are allowed in a visual query (e.g., “price<=$1 M” can be included in a visual query. Without NL interpretation, entering “$1 M” in a GUI field would result in an error). GUI-like expressions are also allowed in a natural language query. For example, a user may enter “Show colonials with color=brick in Pleasantville”. The special GUI expression “color-brick” is used to explicitly avoid an ambiguous NL expression “brick house” which could mean either the siding material or the color of a house.

A. NL Expressions Embedded in Visual Queries

A first intra-modality integration strategy embeds NL expressions in visual queries. The disclosed intra-modality integration strategy allows users to take advantage of multimodality but avoid major modality switching cost.

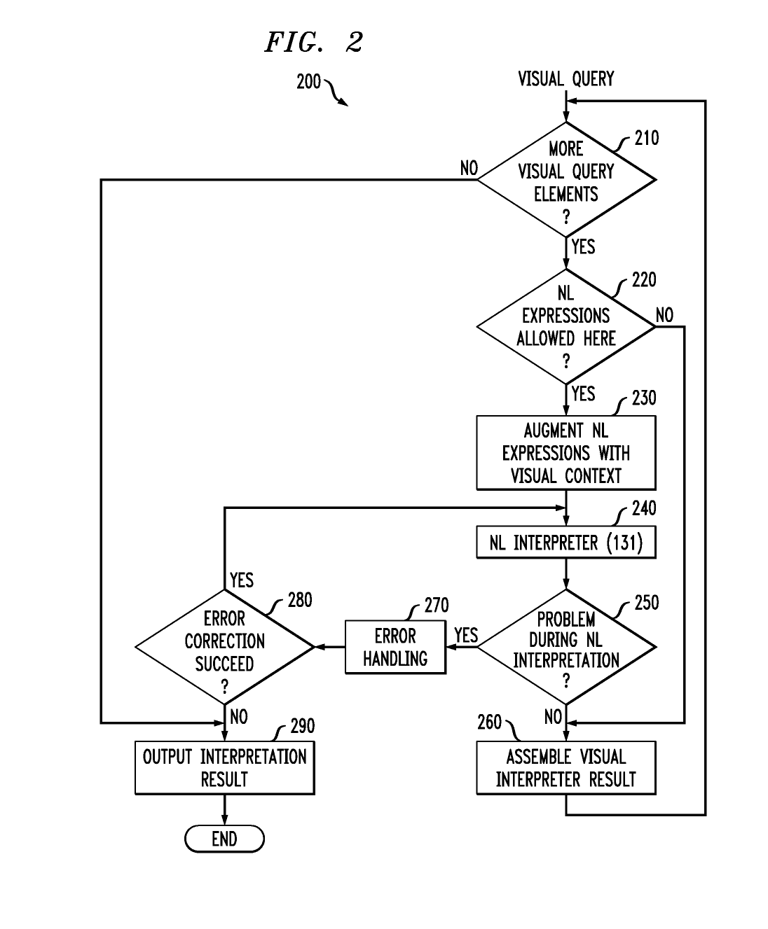

FIG. 2 is a flow diagram illustrating an intra-modality integration process 200 in accordance with an embodiment of the present invention. The disclosed form interpretation process 200 embeds NL expressions in visual queries. As shown in FIG. 2, given a user's visual query, the process 200 processes each visual query element one by one. Examples of visual query element include a query node representing an object in a ontology or a table in a database, a link representing a relation in an ontology or a joint relation between database tables, a GUI combo box specifying possible attributes of an object, or columns in a database table, and a text box specifying possible database values. A test is performed during step 210 to determine if there are additional visual query elements to process.

If it is determined during step 220 that NL expressions are not allowed in a visual element, program control proceeds to step 290 in a conventional manner. If, however, it is determined during step 220 that NL expressions are allowed in a visual element, embedded NI interpretation is trigged in accordance with the invention. First, the system automatically augments each NL expression with appropriate visual context during step 230. For example, if an NL expression “1 M dollars” is specified as the askingPrice of a house in a visual query, the NL expression “1 M dollars” as well as its visual context “Object=house” “Attribute=askingPrice” are sent to the NL interpreter (131) during step 240. The NL interpreter 131 will try to derive a valid interpretation of the NL expression that is also compatible with the associated visual context.

If it is determined during step 250 that a problem is encountered during NL interpretation, an error handling routine is trigged during step 270. If it is determined during step 280 that an error can be resolved by the error handling routine during error handling (e.g., a unique interpretation result can be obtained based on a user's feedback during disambiguation), the system proceeds to step 240 and continues. If it is determined during step 280 that the error cannot be resolved immediately (e.g. an unknown word is detected), an error message is reported and a user needs to resubmit the query after query revision or submit a new query. If a proper interpretation is obtained (i.e., it is determined during step 250 that a problem is not encountered during NL interpretation, or any problems are corrected), the interpretation result of the current visual element is preserved and will be used during step 260 to assemble the final interpretation result for the current visual query.

B. Visual Expressions Embedded in Natural Language Queries

A second intra-modality integration strategy embeds GUI-like expressions in natural language queries. For example, a user may submit a NL query like show color=brick house in Pleasantville The GUI expression “color=brick” is used to avoid a potential ambiguity associated with the NL expression “brick house” because “brick” can be interpreted as both the color or the siding material of a house.

To support embedded GUI-like expressions in NL queries, the interpretation dictionary used by the NL query interpreter 131 is augmented with GUI symbols, such as relational operators like =, <=, >, aggregation operators like sum, count, average, ontology predicates such as located-in, has-parts, attributes of objects and categorical values of an attribute. Then, GUI symbols are processed together with other words in an NL query to form the final interpretation

### Inter-Modality Intra-Turn Integration

According to another aspect of the present invention, an inter-modality intra-turn integration strategy is employed to integrate the visual and natural language techniques. The disclosed integration strategy provides inter-modality intra-turn side-by-side visual and NL query integration. It allows the two full-fledged query interfaces to be used side-by-side within a turn so that part of a query can be specified visually and part of the query can be specified in natural language. For example, in a real estate application, a user may use GUI to specify the siding material of a house so that it avoids a potentially ambiguous NL expression like “brick houses”. Furthermore, directly specifying the city region constraint “in the north” as a natural language query saves the user's time to figure out which city attribute to use in GUI. This feature is especially helpful in dealing with large and complex data space, where a data concept may have a large number of attributes and a user does not always know which one to use for a given value.

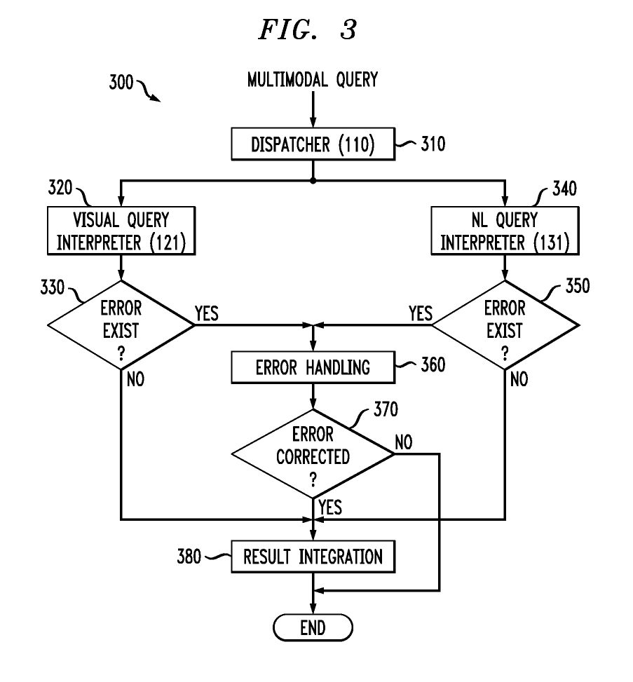

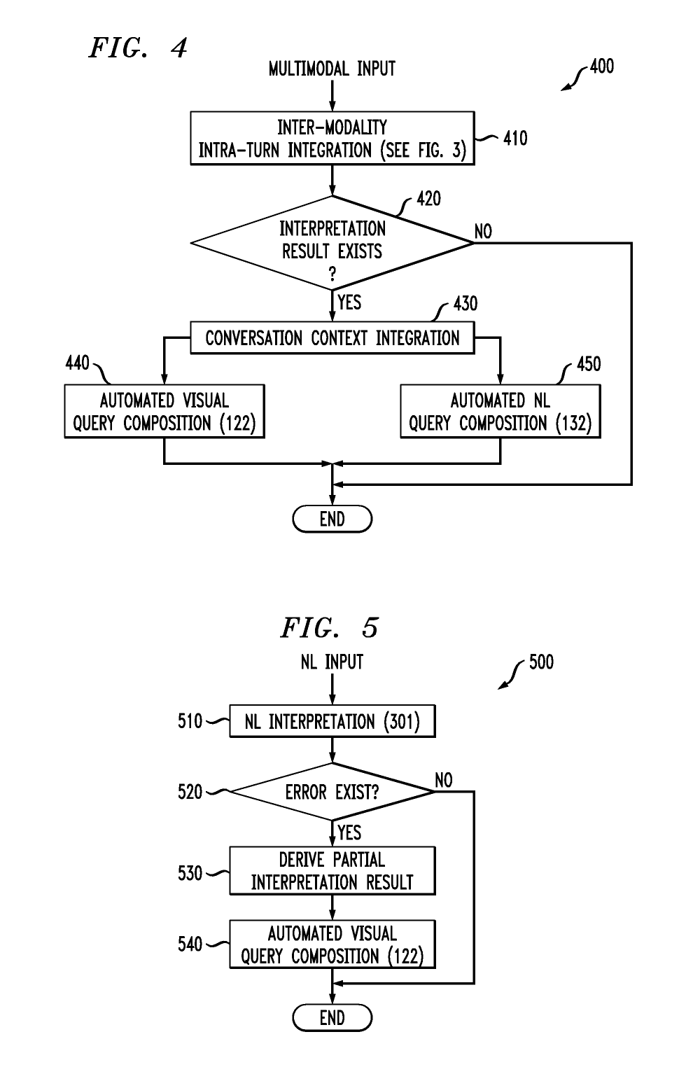

FIG. 3 is a flow diagram illustrating an exemplary inter-modality intra-turn side-by-side integration process 300 in accordance with an embodiment of the present invention. As shown in FIG. 3, a user's multimodal query is received during step 310 and sent to the dispatcher 110. The dispatcher 110 sends the visual part of the query to the visual query interpreter 120 for analysis during step 320. At the same time, the dispatcher 110 also sends the NL part of the query to the NL interpreter 131 during step 340.

If there is no interpretation error in both the visual and the NL queries (determined during steps 330 and 350, respectively), the interpretation results are integrated during step 380 to formulate the final interpretation. If an error is detected during steps 330 or 350, an error handling routine is triggered during step 360. If it is determined during step 370 that the error can be corrected easily by the user (such as NL disambiguation), the user is asked to correct the error. Then, the results from each query modality are integrated during step 380 to form the final interpretation result. If it is determined during step 370 that an error can not be corrected easily, the system will report an error message and wait for the next user query.

In FIG. 3, if a user's input only contains a visual query or an NL query, then only the visual query interpreter 121 or the NL query interpreter 131 is triggered by the dispatcher 110. The interpretation result of the visual or the NL query is used directly as the final interpretation result.

### Inter-Modality, Inter-Turn Context-Preserving Integration

According to another aspect of the invention, an inter-modality inter-turn context-preserving integration strategy is provided. Generally, the inter-modality inter-turn context-preserving integration strategy allows a context-preserving switch from one query to the next. For example, a user can finish one query in one mode and automatically generate the context for the next query in another mode. While it may be difficult to delete a constraint in an NL query, for example, this is relatively straightforward using visual query techniques.

Inter-modality, inter-turn context-preserving integration is useful, for example, in complex information access and exploration tasks in which queries are issued in context and they are not independent of each other. For example, in a trade application, a user may first issues a natural language query “Show shipment with T42p”. Based on this input, an equivalent visual query is automatically created to confirm the interpretation results. It also serves as the visual query context for the following user queries. In the next turn, the user wants to narrow down the dataset to those that arrive by ship or boat. Since he may not know the exact NL expressions to use, the user decides to use GUI to add this constraint in the visual query. With the help of step-by-step prompting in the visual query interface, the user is able to quickly add a “transportMode” constraint with the value “by sea”. Without automatically established visual query context from the previous NL query, it would be very difficult and time consuming for the user to issue the follow up query in GUI.

FIG. 4 is a flow diagram illustrating an inter-modality inter-turn context-preserving integration process 400 in accordance with an embodiment of the present invention. As shown in FIG. 4, the input to the interface 400 can be a visual query, a natural language query or a combination of both. If the input includes both query modalities, the system first combines them together during step 410 using inter-modality intra-turn integration, described above in conjunction with FIG. 3.

If it is determined during step 420 that a valid interpretation is derived during this step, the interpretation result is first combined during step 430 with the conversation history to derive a query interpretation that is context-appropriate. Then, the interpretation result is used by the visual query composer 122 during step 440 to automatically construct a visual query interface. It is also used by the NL query composer 132 during step 450 to construct an equivalent NL query. In the next turn, a user can directly interact with the system-composed visual or NL query to issue a follow up query.

### Cross-Modality NL Error Recovery Based on Partial NL Interpretation Results

According to another aspect of the invention, a cross-modality NL error recovery based on partial NL interpretation strategy is provided (also referred to as visual query based cross-modality NL error handling). Generally, NL interpretation techniques are not robust and certain words may not be understood by the system. The present invention recognizes that visual query techniques can be employed to assist with NL interpretation problems (cross-modality). For example, a visual query can be presented based on the partial NL query that is understood, and visual constraints can be used to specify the portions of the NL query that are missing.

NL interpretation is difficult and interpretation errors may occur frequently. This integration strategy supports a partial NL interpretation-based visual query construction so that NL errors can be corrected easily using the visual query interface. For example, if unknown words are encountered during NL interpretation, the system derives a partial understanding result based on the words it can understand. Based on the partial understanding result, the system automatically generates a visual query to confirm the partial understanding and to serve as the visual query context for error correction. Given the visual interface, a user can focus on revising the visual query to correct NL interpretation problems (such as adding a constraint that was missing or collecting a relation that was misunderstood) without spending time re-entering the information that has already been understood correctly.

FIG. 5 is a flow diagram illustrating a cross-modality natural language error recovery process 500 using visual queries in accordance with an embodiment of the present invention.

As shown in FIG. 5, when a user inputs an NL query, it is sent during step 510 to the NL interpreter 131 for analysis. If it is determined during step 520 that an error is encountered during the interpretation, the system will try to formulate an interpretation result during step 530 based on the part of the query it can understand. For example, by ignoring all the unknown words, the system formulates an interpretation result that can best describe the rest of the words in that query. Given the partial interpretation result, the visual query composer 122 automatically constructs an equivalent visual query during step 540 so that a user can easily revise the visual query to describe the unknown words or to correct an interpretation error in the visual query.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for integrating a visual query interface and a natural language interfaces comprising:
providing an interface that embeds a first of said visual query interface and said natural language interface into a second of said visual query interface and said natural language interface.

2. The method of claim 1, further comprising the step of receiving one or more natural language expressions in a visual query.

3. The method of claim 1, further comprising the step of processing each visual query element in said visual query.

4. The method of claim 3, further comprising the step of applying NL interpretation to each NL expression in said visual query.

5. The method of claim 1, further comprising the step of receiving one or more visual query expressions in a natural language query.

6. The method of claim 5, wherein an interpretation dictionary used by an NL query interpreter is augmented with one or more graphical symbols.

7. A method for integrating a visual query interface and a natural language interfaces comprising:
providing said visual query interface and said natural language interface;
receiving one or more natural language expressions in said natural language interface;
receiving one or more visual query expressions in said visual query interface in a same search turn as said one or more natural language expressions are received; and
processing said one or more natural language expressions and said one or more visual query expressions in said same search turn.

8. The method of claim 7, further comprising the step of applying said one or more natural language expressions to an NL interpreter and said one or more visual query expressions to a visual query interpreter.

9. The method of claim 7, further comprising the step of integrating results from said visual query mode and said natural language mode.

10. A method for integrating a visual query interface and a natural language interface, comprising:
providing said visual query interface and said natural language interface;
receiving a first query comprised of a first of a natural language query and a visual query;
processing said first query; and
creating a substantially equivalent query to said first query in a second of said natural language query and said visual query.

11. The method of claim 10, further comprising the step of processing said substantially equivalent query.

12. The method of claim 10, further comprising the step of providing said substantially equivalent query for editing as a basis for a subsequent query.

13. A method for integrating a visual query interface and a natural language interfaces comprising:
providing said visual query interface and said natural language interface;
receiving a natural language query;
processing said natural language query to determine if a portion of said natural language query is not under stood; and
converting at least a portion of said natural language query to a visual query; and
receiving one or more visual constraints to specify said portion of said natural language query is not understood.

14. The method of claim 13, further comprising the step of applying said natural language query to a natural language interpreter.

15. The method of claim 13, further comprising the step of determining if said natural language query has an error

16. The method of claim 13, further comprising the step of formulating an interpretation result based on a portion part of said natural language query that is understood.

17. The method of claim 16, further comprising the step of generating a partial interpretation result by ignoring one or more unknown words.

18. The method of claim 17, wherein said converting step converts said partial interpretation result to a visual query.

19. The method of claim 18, further comprising the step of receiving one or more revisions to said visual query to describe one or more unknown words.

20. The method of claim 18, further comprising the step of receiving one or more revisions to said visual query to correct an interpretation error in said visual query.
